(19) United States
(12) Patent Application Publication
(10) Pub. No.: US 2023/0106069 A1
(43) Pub. Date: Apr. 6, 2023

(54) System and Device for Advertising on Motor Vehicles

(71) Applicant: David Williams, Dallas, TX (US)

(72) Inventor: David Williams, Dallas, TX (US)

(21) Appl. No.: 17/687,985

(22) Filed: Mar. 7, 2022

Related U.S. Application Data
(60) Provisional application No. 63/245,877, filed on Sep. 19, 2021.

(51) Int. Cl. G06Q 30/02; G06K 19/06

(52) U.S. Cl. CPC G06Q 30/0265; G06K 19/06037

(57) ABSTRACT

The present invention relates to a system, a method and a novel advertising device for the mobile advertising of a business. The advertising device includes a QR code-based advertisement printed on vinyl, or transmitted to a registrant, which can be attached to any available space on a vehicle such as a tow truck, a passenger vehicle, or a box truck. The QR code is configured to be scanned by a digital camera and embeds a URL or additional information about the business for which the QR code is associated. The QR code is prepared by a QR generation service on request of a business and can be attached, connected, or transmitted, to one or more vehicles selected by the business wherein the vehicles are registered by vehicle operators or drivers.

### CROSS-REFERENCE TO RELATED APPLICATION

The present application claims priority to, and the benefit of, U.S. Provisional Application No. 63/245,877, which was filed on September 19th, 2021 and is incorporated herein by reference in its entirety.

### FIELD OF THE INVENTION

The present invention relates generally to Quick Response code (QR code) based advertising systems. More specifically, the present invention relates to an advertising system and service using a QR code-based advertisement wherein the advertisement is attached to an interior or an exterior of a vehicle. The QR code can be specific to a business and can be scanned by an onlooker for making a purchase from the business or retrieving more information about the business. A business can select one or more vehicles having available spaces for advertisements and vehicles can be registered by vehicle operators or drivers. Accordingly, the present disclosure makes specific reference thereto. Nonetheless, it is to be appreciated that aspects of the present invention are also equally applicable to other like applications, devices, and methods of manufacture.

### BACKGROUND

By way of background, marketing is a strategy that businesses do in order to advertise their businesses. Marketing helps businesses to increase their presence and sales. Marketing also helps boost sales and creates revenue options. Marketing informs customers about the products or services offered by a business. Through marketing, customers get to know about the value of the products, their usage, and additional information that might be helpful to the customers. A specific type of marketing to target end customers is business-to-consumer (B2C) marketing. B2C marketing promotes the business directly to consumers through advertisements.

Conventional ways of marketing, and in particular advertisements direct to consumers, are costly and ineffective. Hundreds and thousands of dollars are spent by businesses for advertisements of a few seconds. This may be feasible for big businesses but for medium and small-scale businesses, this type of marketing is not effective. Some businesses, such as chiropractors, accident-injury lawyers, collision centers, car dealerships and others, require local targeting of the customers that are in the same or surrounding cities, which is both efficient and cost-effective.

Current billboard and vinyl advertisements that are adhered to various places and automobiles are static, and do not provide additional information to the customers or onlookers. They are not effective and do not enable people to take an instant action after looking at the advertisements. Businesses require advertisement methods and devices that can increase the traction and interactivity with their static advertisements.

Further, once physical advertisements are placed on businesses, there are no means for them to unsubscribe the advertisement services. Vehicle owners are not motivated enough to advertise businesses, as they are not paid adequately for placing advertisements on their vehicles. Conventional physical advertisements also decrease the aesthetic appeal of the vehicles. Current systems also do not provide an efficient system for the businesses to select vehicles and places where they want their advertisements to be placed.

Therefore, there exists a long felt need in the art for an advertising system and device that can increase interactivity of the advertisements placed on the vehicles. There is also a long felt need in the art for an advertising system and device that allows businesses to select vehicles on which they want their advertisements to be placed. Additionally, there is a long felt need in the art for an advertising system and device that is efficient and cost-effective. Moreover, there is a long felt need in the art for an advertising system and device that can be used by medium and small-scale businesses. Furthermore, there is a long felt need in the art for an improved advertising system and device that offers an effective mechanism to connect customers and businesses through advertisements. Finally, there is a long felt need in the art for an advertising system and device that provides customization to the businesses advertising therewith, and also enables payments effectively to the vehicle operators on whose vehicles advertisements are placed.

The subject matter disclosed and claimed herein, in one embodiment thereof, comprises a QR code-based advertisement vinyl device for businesses. The QR code-based advertisement device is configured to attach to the exterior or the interior of a vehicle for advertising or marketing purposes. The advertisement vinyl device includes a logo of a business, contact information of the business, and a QR code configured to be scanned by an imaging device such as a digital camera. The QR code having embedded information that enables individuals scanning the QR code to access more information or perform shopping from the business wherein the QR code and the logo are printed on vinyl. The QR codes are specifically designed and encoded with information of a specific business and they redirect a user to the website of the business.

In this manner, the advertising system and QR device of the present invention accomplishes all of the forgoing objectives and provides users with a QR code that can be attached to a vehicle for the purpose of advertising. The QR code can be printed on vinyl and attached to a vehicle. When a person scans the QR code, the person is redirected to the online presence of the business for which the QR code is made. Custom QR codes can be generated for specific businesses.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a QR code-based advertisement vinyl device for businesses. The QR code-based advertisement device is configured to attach to the exterior or interior of a vehicle for advertising or marketing purposes. The advertisement vinyl device further comprising a logo of a business, contact information of the business, and a QR code configured to be scanned by an imaging device such as a digital camera. The QR code having embedded information that enables individuals scanning the QR code to access more information or perform shopping from the business wherein the QR code and the logo are printed on vinyl. The QR codes are specifically designed and encoded with information of a specific business and redirects a user to the website of the business.

In yet another embodiment, the QR code is prepared by the request of a business and includes a logo of the business.

The subject matter disclosed and claimed herein, in another embodiment thereof, comprises an advertising system for advertising on available spaces inside and outside of motor vehicles. The advertising system includes a QR generation service configured for receiving advertisement requests from a business for placing advertisements on motor vehicles, receiving registration information from one or more vehicle operators or drivers for registering their vehicles for advertisement placement, preparing a QR code customized to the business along with a logo and attaching the QR code along with the logo on the selected motor vehicle by the business.

In yet another embodiment, the QR generation service receives a monthly fee and a setup fee for the QR-based advertisement from the business.

In yet another embodiment, the vehicle operator or driver uploads vehicle’s license plate number, license plate state, major city in which driver operates, payment method, vehicle year, vehicle model, average miles per day and average number of persons per day in the vehicle during registration of the vehicle.

In yet another embodiment of the present invention, a method for using available spaces of a motor vehicle for advertising for a business is disclosed. The method includes the steps of a business selecting a vehicle for placement of QR-based advertisement wherein the vehicle is selected from a plurality of vehicles having available space for advertisements, created by an advertising service, a vinyl advertisement having a QR code along with a logo for placement on available spaces on the selected vehicle and crediting the operator of the vehicle when the advertisement is placed on the vehicle.

In yet another embodiment, the business pays a one-time fee and a recurring fee, and can select one or more places of one or more vehicles. In yet another embodiment, the vehicle can be selected from a wrecker, a passenger vehicle or a box truck.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of the motor vehicle available space advertising system of the present invention in accordance with the disclosed architecture;

FIG. 2 illustrates a flow diagram showing exemplary steps performed by a business for buying available motor vehicles advertising spaces for marketing and advertising purposes using custom QR advertising code generation service in accordance with the disclosed architecture;

FIG. 3 illustrates a flow diagram showing exemplary steps performed by a vehicle driver or operator for registering motor vehicles with available motor vehicles advertising spaces that can be used by businesses for marketing and advertising in accordance with the disclosed architecture;

FIG. 4 illustrates an exemplary user interface showing information to be input by a vehicle driver or operator for registering their vehicles to use ‘rolling advertisement’ service of the present invention in accordance with the disclosed architecture;

FIG. 5 illustrates an exemplary ‘rolling advertisement’ or advertising QR code used in the system of the present invention by the ‘rolling advertisement’ service for placement on a motor vehicle in accordance with the disclosed architecture;

FIG. 6 illustrates a partial view of a vehicle with an exemplary ‘rolling advertisement’ placed on the back door for marketing and advertising purposes in accordance with the disclosed architecture;

FIG. 7 illustrates various size and placement options provided to the vehicle operators and businesses for placing the advertising QR codes in accordance with the disclosed architecture; and

FIG. 8 illustrates a flow diagram showing the steps of a combined process of assigning a QR code to a vehicle to which the QR code is attached for purposes of advertising or marketing in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an advertising system and device that can increase interactivity of the advertisements placed on the vehicles. There is also a long felt need in the art for an advertising system and device that allows businesses to select vehicles on which they want their advertisements to be placed. Additionally, there is a long felt need in the art for an advertising system and device that is efficient and cost-effective. Moreover, there is a long felt need in the art for an advertising system and device that can be used by medium and small-scale businesses. Furthermore, there is a long felt need in the art for an improved advertising system and device that offers an effective mechanism to connect customers and businesses through advertisements. Finally, there is a long felt need in the art for an advertising system and device that provides customization to the businesses advertising therewith, and also enables payments effectively to the vehicle operators on whose vehicles advertisements are placed.

The present invention, in one exemplary embodiment, is a novel advertising system for advertising on available spaces inside and on the exterior of motor vehicles, for example, such as wreckers, passenger vehicles and box trucks. The advertising system includes a QR generation service configured for receiving advertisement requests from a business for placing advertisements on motor vehicles, receiving registration information from one or more vehicle operators or drivers for registering their vehicles for advertisement placement, preparing a QR code customized to the business along with a logo and attaching the QR code along with the logo on the selected motor vehicle for the business.

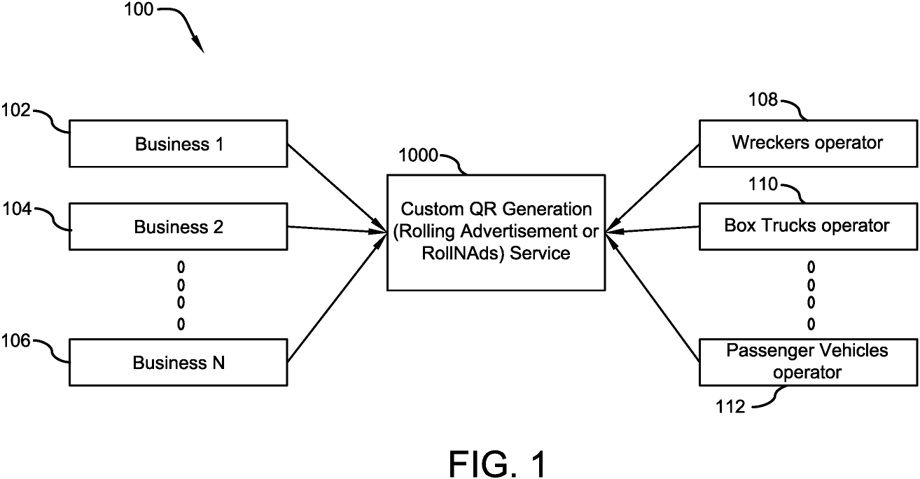

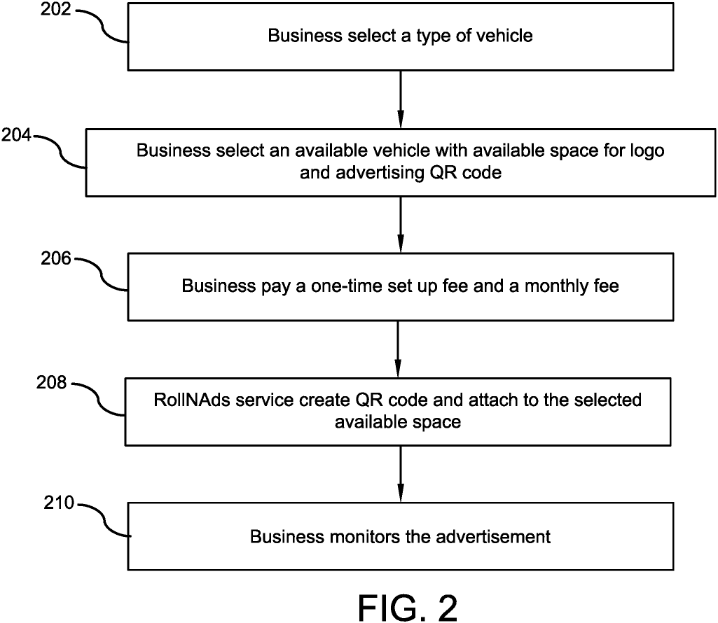

Referring initially to the drawings, FIG. 1 illustrates a schematic view of one potential embodiment of a motor vehicle available space advertising system of the present invention in accordance with the disclosed architecture. FIG. 1 shows several advantageous features of the present invention, but as will be described below, the invention can be provided in several shapes, sizes, combinations of features and components and varying numbers and functions of the components. The motor vehicle available space advertising system 100 is designed to offer available advertising space on motor vehicles by attaching or connecting customized quick response (QR) codes to the available advertising spaces that can be scanned and used for displaying an advertisement. The advertising system 100 enables the owners or operators of the vehicles to use their vehicles for marketing or advertising purposes, and offers a way to connect customers and businesses through advertisements. A plurality of businesses shown as business #1, business #2, up to business N, identified as elements 102,104,106, connect to the custom QR generation service 1000 to buy or rent available motor vehicle advertising spaces. A customized QR code, optionally with a logo of the business, can be placed on, or electronically connected with, the purchased or rented motor vehicle advertising space for advertising and scanning purposes as best shown in FIG. 2. The custom QR generation service 1000 can be configured to generate, transmit and/or print customized QR codes for the purpose of advertising and can also be used for payment transactions.

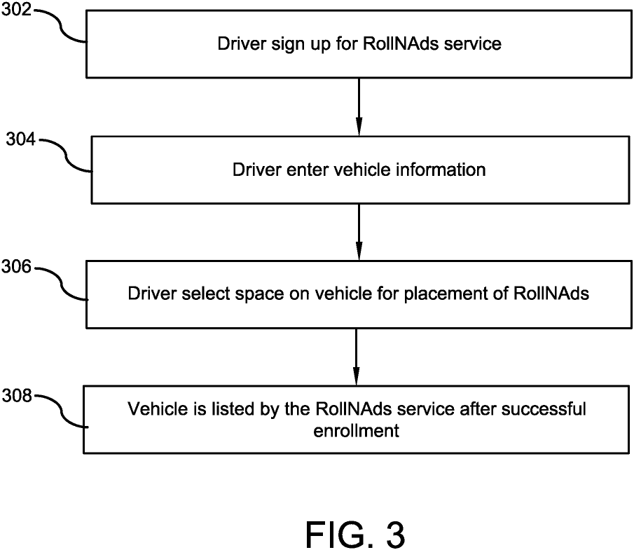

Similarly, a vehicle driver and/or operator can connect and register their vehicles having available advertising spaces with the custom QR generation service 1000. A plurality of vehicle operators, for example a wrecker or tow truck operator 108, a box truck operator 110 and a passenger vehicle operator 112 can register or link their vehicles on the custom QR generation service 1000 as best described in FIG. 3.

It should be appreciated that the businesses can subscribe to pay a setup fee for generation of their QR code having a logo and a monthly fee, for example for attaching their customized QR code to the vehicle of their desire. Vehicle operators can receive a monthly payment, a ‘run-time’ payment, and/or a ‘roll-time’ payment when their vehicle is selected for placement or transmission of a QR code and the payment can be received by the vehicle operators on a monthly basis, for example.

The custom QR generation service 1000 provides a plurality of user interfaces for the businesses and vehicle operators to register and sign-up. Further, the custom QR advertising code generation service 1000 can be accessed through a website (such as https://www.’rolling advertisement’s.com/) or through a smartphone application that can be downloaded from a play store, such as Google playstore or Apple store. The custom QR generation service 1000 can be accessed by any business or vehicle operator using any local area network (LAN), metropolitan area network (MAN), wide area network (WAN), a public data network (e.g., the Internet), short range wireless network or any other suitable packet-switched network, such as a commercially owned, proprietary packet-switched network, e.g., a proprietary cable or fiber-optic network and the like, or any combination thereof. In addition, the wireless network can be, for example a cellular network and can employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Internet Protocol (IP) data casting, satellite, mobile ad-hoc network (MANET) and the like, or any combination thereof.

The customized QR code includes a scannable code that can be scanned using an imaging device, such as a camera of a smartphone. A URL of the business for which the customized QR code advertisement is designed is embedded in the QR code and the company introduction information is provided to the customer after scanning of the code.

FIG. 2 illustrates a flow diagram showing exemplary steps performed by a business for buying available motor vehicles advertising spaces for marketing and advertising purposes using custom QR advertising code generation service 1000 in accordance with the disclosed architecture. Initially, businesses such as chiropractors, accident-injury lawyers, collision centers, car dealership, schools, or any other businesses can select a type of vehicle, such as tow trucks, box trucks, passenger vehicles or any other vehicle type that includes advertising space for their customized advertising QR code (Block 202). Thereafter, for the selected vehicle type, the business can select at least one specific vehicle having at least one available space for the logo and advertisement QR code placement (Block 204). It should be noted that the listed vehicles can also be registered with the service 1000. Then, for successfully placing the order, the business can pay a one-time set up fee for generating the advertising QR code and a monthly fee, a ‘run-time’ fee, or a ‘rolling-time’ fee that can be auto-renewed as per the preferences of the business (Block 206). Once the checkout is complete, the custom QR advertising code generation service 1000 creates the advertising QR code and attaches to the available space selected by the business (Block 208). Once the logo and the advertising QR code is placed, the business can monitor the QR code and can also cancel the subscription in the future (Block 210).

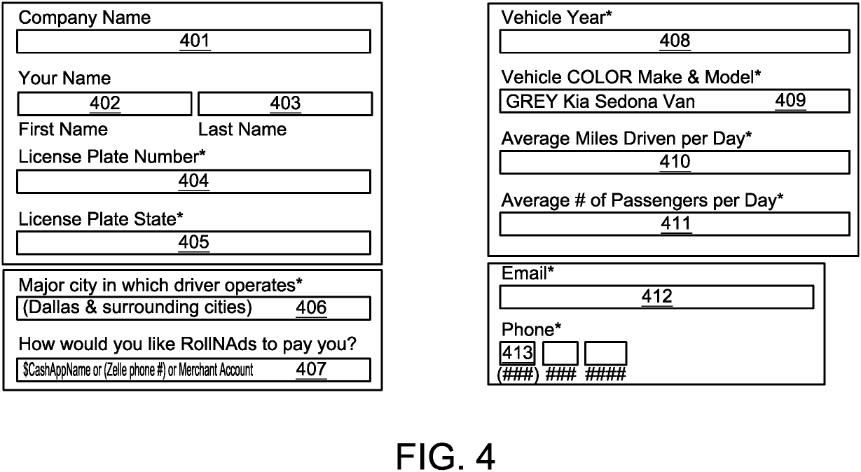

FIG. 3 illustrates a flow diagram showing the exemplary steps performed by a vehicle driver or operator for registering motor vehicles with available motor vehicle advertising spaces that can be used by businesses for marketing and advertising in accordance with the disclosed architecture. Initially, a driver enrolls or signs-up on the ‘rolling advertisement’ service 1000 for an advertising QR code or ‘rolling advertisement’ (Block 302). Then, the driver enters the necessary vehicle information such as vehicle name, registration number and other particulars (Block 304). The necessary information to be input while registering the vehicle is best described in FIG. 4. Thereafter, the driver selects one or more spaces on the vehicle motor that can be used by the service 1000 for placing the ‘rolling advertisement’ of a business that can then select the vehicle for advertising purposes (Block 306). Finally, after successful registration of the vehicle; the vehicle, along with the available advertising spaces, can be listed on the website of the service and can be selected by businesses for placing their logos and advertisements therewith (Block 308).

FIG. 4 illustrates an exemplary user interface showing information to be input by vehicle drivers or operators for registering their vehicles to use the ‘rolling advertisement’ service 1000 of the present invention in accordance with the disclosed architecture. As shown, a driver or vehicle operator inputs the company name 401 to which the vehicle is associated and the vehicle operator’s first name 402 and last name 403. For vehicle information, license plate number 404 for verifying the identity of the vehicle, license plate state 405, one or more major cities 406 in which the vehicle is driven are input by the user. For payment information, one or more electronic payment remittance ways, such as account number or phone number 407 are inputted. Along with the information stated supra, vehicle year 408, model number and color information 409, average miles (or time duration) driven per day 410 and average number of passengers driven per day 411 by the vehicle operator are also included. This information is used by the service 1000 for placing an advertisement of a business that can be effectively benefitted by the vehicle.

For contacting the driver or the operator of the vehicle and for providing regular updates, an email 412 and a contact number 413 are provided by the operator. It should be noted that vehicle information is displayed on the user interface that allows a business to select a vehicle as per their preferences.

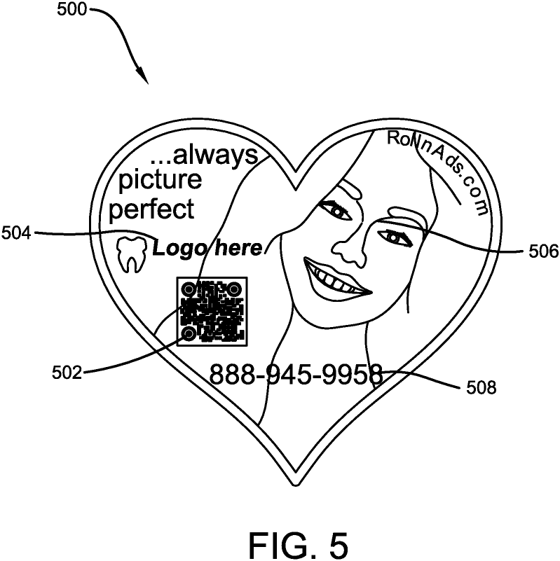

FIG. 5 illustrates an exemplary ‘rolling advertisement’ or advertising QR code used in the system of the present invention by the ‘rolling advertisement’ service 1000 for placement on or in a motor vehicle in accordance with the disclosed architecture. The ‘rolling advertisement’ 500 can be of any shape such as a heart shape, for example. The business for which ‘rolling advertisement’ 500 is prepared can select the shape of the advertisement. The ‘rolling advertisement’ 500 includes a QR code 502 that can be scanned by an imaging device such as a smartphone that reads the embedded URL or information of the QR code 502 for review by a user scanning the code. The user can be taken to the website of the business such as, for example Jefferson Dental Care 504. A logo 506 can also be present on the advertisement that can either be provided by the business during registration or can be created by the service 1000 based on the preference of the business. Any additional information such as a contact number 508 or any other relevant information can also be present on the advertisement 500. It should be understood that by placing the advertisement 500 on a motor vehicle, the drivers can earn money based upon the miles driven or time duration that the vehicle is driven, and also the businesses get a cost-effective and efficient marketing and advertising method.

The shape, size, and design can be customized as per businesses requirements. Further, the advertisement along with the QR code can be printed on vinyl, or can be an electronic screen attached to or placed in a vehicle. The ‘rolling advertisement’ offers a way to connect customers and businesses through advertisements.

In one potential embodiment, the QR code of the ‘rolling advertisement’ can contain information directing the handheld device with which the code is scanned to communicate with a pricing information provider. For example, a uniform resource locator (URL) can be directed to a merchant website or fileserver. After the code is decoded, the handheld device will initiate wireless communication in order to access the specified URL. Access of the URL can show pricing information which relates to prices for products or services. Convenience of QR codes can be used to take advantage of limited time pricing offers such as sales, discounts or special offers. The consumer can simply scan the QR code displayed on the ‘rolling advertisement’ to obtain more information that can be used for shopping and completing electronic transactions. As stated earlier, QR codes are captured using a digital camera that can be positioned on any side of the handheld device. The camera must have sufficient resolving capability to capture the different data sectors of a QR code.

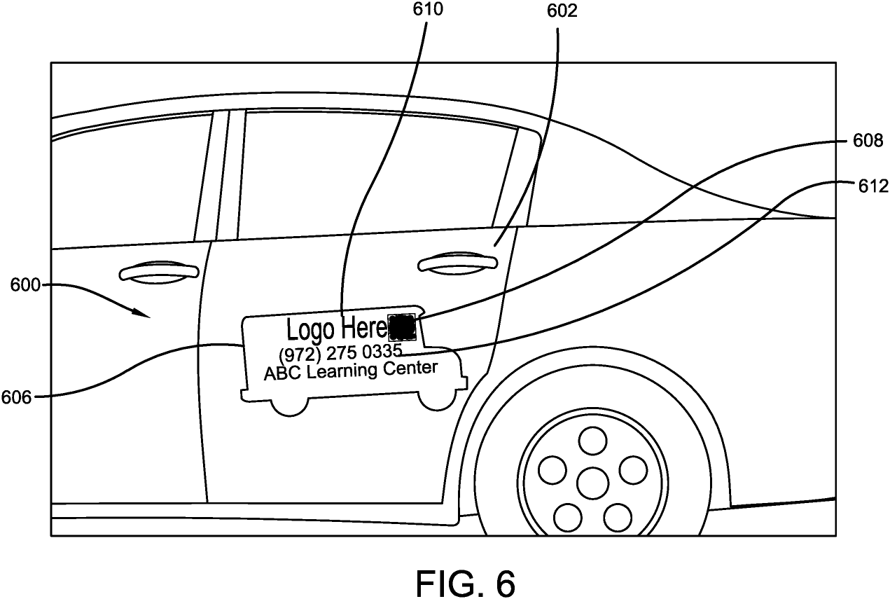

FIG. 6 illustrates a partial view of a vehicle with an exemplary ‘rolling advertisement’ placed on a vehicle back door for marketing and advertising purposes in accordance with the disclosed architecture. One of the advantages of ‘rolling advertisement’ or QR code advertisement of the present invention is that they can be placed on any available space of a motor vehicle for providing efficient marketing to the businesses. As shown, the back door 602 of the vehicle 600 includes the exemplary ‘rolling advertisement’ 606 prepared using the ‘rolling advertisement’ service 1000. The ‘rolling advertisement’ 606 includes a QR code 608 that can be scanned along with the logo 610 and other contact information such as contact number 612 of the business. It should be appreciated that once the business stops the subscription, the ‘rolling advertisement’ can be removed from the vehicle, the electronic screen can be changed to another business or the space/screen can be made available for other businesses to subscribe.

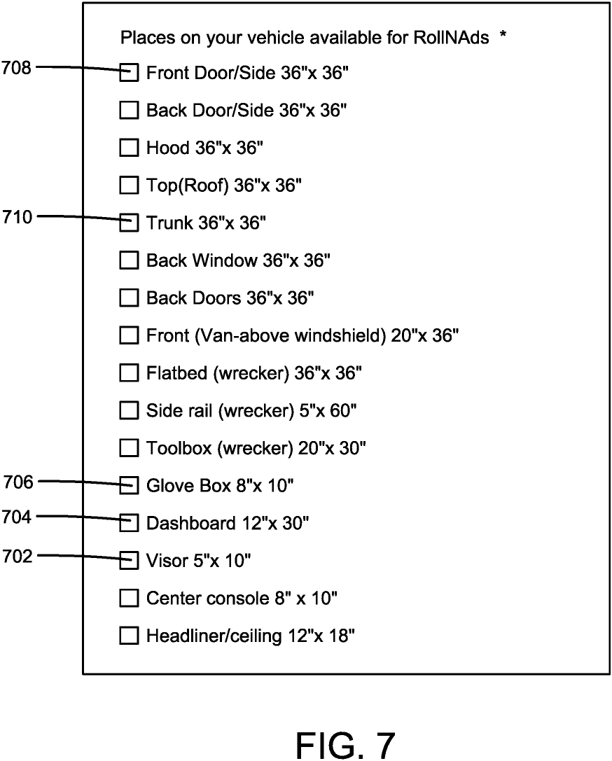

FIG. 7 illustrates various size and placement options provided to the vehicle operators and businesses for placing the advertising QR codes in accordance with the disclosed architecture. As stated earlier, various types of vehicles such as tow trucks, box trucks or passenger vehicles can be registered for advertising purposes. Therefore, for providing adequate space to a ‘rolling advertisement’ for a business, the present invention provides a plurality of sizes and placement options that can be selected by businesses and vehicle operators for placement of their advertisement. As shown, placement of the advertisement can be inside a vehicle such as on a visor 702, dashboard 704, glove box 706, and/or on an exterior surface such as a front door 708, a trunk surface 710 and many more places as illustrated in FIG. 7.

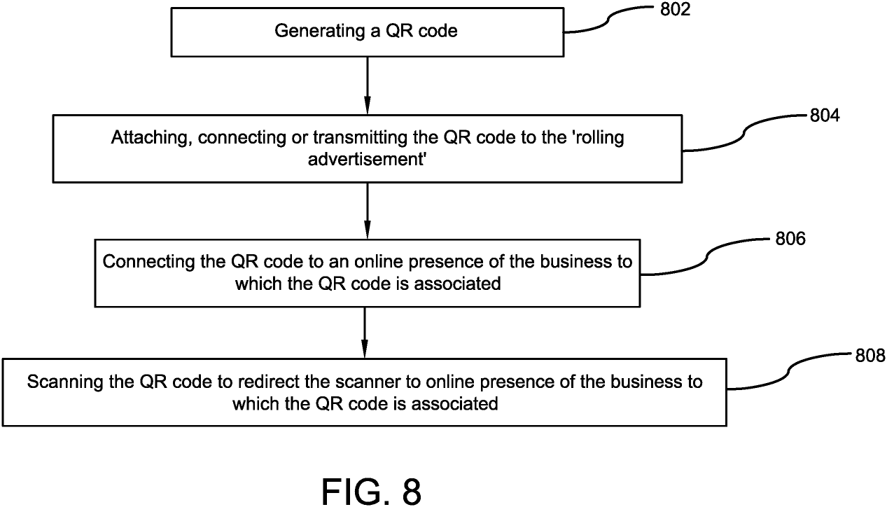

FIG. 8 illustrates a flow diagram showing the steps of combining the process of assigning a QR code to a business to which the QR code is attached for purpose of advertising or marketing in accordance with the disclosed architecture. As shown, initially, a QR code is generated by the ‘rolling advertisement’ service 1000 of the present invention (Block 802). Then, the QR code is attached, mounted, communicated or connected to a vehicle ‘rolling advertisement’ at an available space (Block 804). Thereafter, the QR code is connected/assigned/redirected to an online presence of the business to which the QR code is associated (Block 806) and finally, scanning the QR code by a scanner or customer to redirect the scanner to the online presence of the business to which QR code is associated for advertising or marketing (Block 808).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motor vehicle available space advertising system”, “advertising system”, and “system” are interchangeable and refer to the motor vehicle available space advertising system 100 of the present invention. Also, as used herein “QR code”, “custom QR advertising code”, “rolling advertisement” and “advertising QR code” are interchangeable and refer to the advertising QR code 500,606 of the present invention.

Notwithstanding the forgoing, the motor vehicle available space advertising system 100 and the advertising QR code 500, 606 of the present invention can be of any suitable size and configuration as is known in the art without affecting the overall concept of the invention, provided that it accomplishes the above-stated objectives. One of ordinary skill in the art will appreciate that the size, configuration and material of the motor vehicle available space advertising system 100 and the advertising QR code 500, 606 as shown in the FIGS. are for illustrative purposes only, and that many other sizes, shapes and electronics of the motor vehicle available space advertising system 100 and the advertising QR code 500, 606 are well within the scope of the present disclosure. Although the dimensions of the motor vehicle available space advertising system 100 and the advertising QR code 500, 606 are important design parameters for user convenience, the motor vehicle available space advertising system 100 and the advertising QR code 500, 606 can be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motor vehicle space advertising system comprising:
a motor vehicle comprised of an advertising space;
wherein said advertising space includes a first scannable QR code and a first associated business information with said first scannable QR code;
wherein said advertising space is an electronic screen;
wherein scanning of said first scannable QR code directs a scanner to an associated first business; and
a first fee is generated through a first run-time of said first associated business information and a run-time of said motor vehicle.

2. The motor vehicle space advertising system of claim 1 further comprising a second scannable QR code and a second associated business information with said second scannable QR code, wherein scanning of said second scannable QR code directs the scanner to an associated second business information.

3. The motor vehicle space advertising system of claim 2 further comprising a second fee that is generated through a second run-time of said second associated business information and said run-time of said motor vehicle.

4. The motor vehicle space advertising system of claim 3, further comprising a QR generation service configured to generate and transmit at least said first scannable QR code, said first associated business information, said second scannable QR code, and said second associated business information to said advertising system of said motor vehicle.

5. The motor vehicle space advertising system of claim 4, wherein said QR generation service transmits at least said first fee and said second fee to an operator of said motor vehicle.

6. A method of using a vehicle space for advertising, the method comprising the steps of:
registering a motor vehicle with an advertising system, wherein said motor vehicle comprises an advertising space;
generating a first scannable QR code and a first associated business information with said first scannable QR code;
transmitting said first scannable QR code and said first associated business information with said first scannable QR code to said advertising space, wherein said advertising space is an electronic screen;
scanning of said first scannable QR code directs a scanner to a first associated business; and
generating a first fee through a first run-time of said first associated business information and a run-time of said motor vehicle.

7. The method of claim 6 further comprising the steps of:
generating a second scannable QR code and a second associated business information with said second scannable QR code; and
transmitting said second scannable QR code and said second associated business information with said second scannable QR code.

8. The method of claim 7 further comprising a step of scanning the second scannable QR code to direct the scanner to an associated second business.

9. The method of claim 8 further comprising a step of generating a second fee through a second run-time of said second associated business information and said run-time of said motor vehicle.

10. The method of claim 9 further comprising a step of transmitting at least said first fee and said second fee to an operator of said motor vehicle.

11. The method of claim 10, wherein said motor vehicle is selected from a group consisting of a tow truck, a box truck and a passenger vehicle.

12. The method of claim 11 further comprising a step of affixing said electronic screen to an area selected from a group consisting of a vehicle door, a vehicle side, a vehicle trunk, a vehicle hood, a vehicle roof, a vehicle window, a vehicle side rail and a vehicle toolbox.

13. The method of claim 11 further comprising a step of affixing said electronic screen to an area selected from a group consisting of a vehicle glove box, a vehicle dashboard, a vehicle visor, a vehicle center console, and a vehicle headliner.

14. A method for using a vehicle space for advertising, the method comprising the steps of:
registering a motor vehicle with an advertising system, wherein said motor vehicle comprises an advertising space;
generating a first scannable QR code and a first associated business information with said first scannable QR code;
printing said first scannable QR code and said first associated business information with said first scannable QR code;
mounting said first scannable QR code and said first associated business information with said first scannable QR code to said advertising space;
scanning of said first scannable QR code directs a scanner to an associated first business; and
generating a first fee through a first run-time of said first associated business information and a run-time of said motor vehicle.

15. The method of claim 14 further comprising the steps of:
generating a second scannable QR code and a second associated business information with said second scannable QR code; and
printing said second scannable QR code and said second associated business information with said second scannable QR code.

16. The method of claim 15 further comprising a step of mounting said second scannable QR code and said second associated business information with said second scannable QR code to said advertising space.

17. The method of claim 16 further comprising a step of scanning of said second scannable QR code directs the scanner to an associated second business.

18. The method of claim 17, wherein said advertising space is an area selected from a group consisting of a vehicle door, a vehicle side, a vehicle trunk, a vehicle hood, a vehicle roof, a vehicle window, a vehicle side rail and a vehicle toolbox.

19. The method of claim 17, wherein said advertising space is an area selected from a group consisting of a vehicle glove box, a vehicle dashboard, a vehicle visor, a vehicle center console and a vehicle headliner.

20. The method of claim 17 further comprising a step of generating a second fee through a second run-time of said second associated business information and said run-time of said motor vehicle.
